(19) United States
(12) Patent Application Publication
(10) Pub. No.: US 2024/0311663 A1
(43) Pub. Date: Sep. 19, 2024

(54) INFERENCE DEVICE

(71) Applicant: FUJIFILM Corporation, Tokyo (JP)

(72) Inventor: Seiji TANAKA, Saitama-shi (JP)

(73) Assignee: FUJIFILM Corporation, Tokyo (JP)

(21) Appl. No.: 18/676,409

(22) Filed: May 28, 2024

Related U.S. Application Data
(63) Continuation of application No. PCT/JP2022/042421, filed on Nov. 15, 2022.

(30) Foreign Application Priority Data
Dec. 14, 2021 (JP) 2021-202876

(51) Int. Cl. G06N 5/04

(52) U.S. Cl. CPC G06N 5/04

(57) ABSTRACT

An inference device includes a first arithmetic module and a second arithmetic module that execute arithmetic processing including a convolution process and a pooling process. The first arithmetic module includes a first memory that stores a plurality of first row data items generated by dividing first image data for each first number of pixels in a row direction and a plurality of first arithmetic units that execute a first convolution process on the plurality of first row data items. The second arithmetic module includes a second memory that stores a plurality of second row data items generated by dividing second image data for each second number of pixels in the row direction and a plurality of second arithmetic units that execute a second convolution process on the plurality of second row data items. The first image data and the second image data have different numbers of channels.

### CROSS-REFERENCE TO RELATED APPLICATION

This application is a continuation application of International Application No. PCT/JP2022/042421, filed Nov. 15, 2022, the disclosure of which is incorporated herein by reference in its entirety. Further, this application claims priority from Japanese Patent Application No. 2021-202876 filed on Dec. 14, 2021, the disclosure of which is incorporated herein by reference in its entirety.

### BACKGROUND

### 1. Technical Field

The technology of the present disclosure relates to an inference device.

### 2. Description of the Related Art

JP2009-080693A discloses an arithmetic processing device that performs an operation on input data to generate operation result data and that executes a network operation in a hierarchical network in which a plurality of logical processing nodes are connected. The arithmetic processing device calculates an amount of memory required for a network operation on the basis of a configuration of the network operation, for each of a plurality of types of buffer allocation methods that allocate, to a memory, a storage area for an intermediate buffer for holding operation result data, corresponding to each of a plurality of processing nodes constituting a network, and executes the network operation in an execution order corresponding to a buffer allocation method selected on the basis of the calculated amount of memory.

### SUMMARY

An embodiment according to the technology of the present disclosure provides an inference device that can increase a processing speed.

In order to achieve the above object, according to the present disclosure, there is provided an inference device for performing an inference using machine-learned data. The inference device comprises: a first arithmetic module and a second arithmetic module that execute arithmetic processing including a convolution process and a pooling process. The first arithmetic module includes a first memory that stores a plurality of first row data items generated by dividing input first image data for each first number of pixels in a row direction and a plurality of first arithmetic units that execute a first convolution process on the plurality of first row data items. The second arithmetic module includes a second memory that stores a plurality of second row data items generated by dividing input second image data for each second number of pixels in the row direction and a plurality of second arithmetic units that execute a second convolution process on the plurality of second row data items. The number of channels of the first image data is different from the number of channels of the second image data, and a first number, which is the number of the first arithmetic units that execute the first convolution process once on the plurality of first row data items in parallel, is different from a second number which is the number of the second arithmetic units that execute the second convolution process once on the plurality of second row data items in parallel.

Preferably, the second image data is image data including a feature amount that is generated by the execution of the arithmetic processing on the first image data by the first arithmetic module.

Preferably, the number of channels of the second image data is larger than the number of channels of the first image data, and the first number is larger than the second number.

Preferably, the number of pixels processed in the second image data input to the second arithmetic module is smaller than the number of pixels processed in the first image data input to the first arithmetic module.

Preferably, the arithmetic processing by the first arithmetic module and the arithmetic processing by the second arithmetic module are executed in parallel.

Preferably, a unit of data storage in the first memory corresponds to the first number of pixels, a size of a filter used in the first convolution process, and the number of channels of the filter used in the first convolution process.

Preferably, a unit of data storage in the second memory corresponds to the second number of pixels, a size of a filter used in the second convolution process, and the number of channels of the filter used in the second convolution process.

Preferably, the number of filters used in the second convolution process is larger than the number of filters used in the first convolution process.

Preferably, the first row data is data corresponding to some rows of the first image data.

Preferably, the inference device further comprises: a third memory that has a larger data storage capacity than the first memory and the second memory and that stores feature image data including a feature amount generated by the first arithmetic module; and a third arithmetic module that upsamples input image data. Preferably, the first arithmetic module is a module that downsamples the first image data, and the third arithmetic module upsamples the input image data and generates the first image data corrected using the feature image data stored in the third memory.

### BRIEF DESCRIPTION OF THE DRAWINGS

Exemplary embodiments according to the technique of the present disclosure will be described in detail based on the following figures, wherein:

FIG. 1 is a diagram illustrating an example of a configuration of an inference device,

FIG. 2 is a diagram conceptually illustrating an example of a feature amount extraction process and a classification process,

FIG. 3 is a diagram illustrating a convolution process and a pooling process in detail,

FIG. 4 is a diagram illustrating a configuration of a k-th channel of a filter,

FIG. 5 is a block diagram illustrating an example of a configuration of a feature amount extraction unit,

FIG. 6 is a diagram illustrating an example of an image data division process,

FIG. 7 is a diagram illustrating an example of a configuration of a line memory comprised in a first arithmetic module,

FIG. 8 is a diagram illustrating an example of a configuration of a line memory comprised in a second arithmetic module,

FIG. 9 is a diagram illustrating a first convolution process,

FIG. 10 is a diagram illustrating a second convolution process,

FIG. 11 is a block diagram illustrating an example of a configuration of an ALU,

FIG. 12 is a flowchart illustrating an example of a flow of the first convolution process performed once by the ALU,

FIG. 13 is a diagram conceptually illustrating the first convolution process performed once by the ALU,

FIG. 14 is a diagram conceptually illustrating a first feature amount extraction process and a second feature amount extraction process,

FIGS. 15A and 15B are diagrams illustrating timings of the first feature amount extraction process and the second feature amount extraction process,

FIG. 16 is a block diagram illustrating a configuration of a feature amount extraction unit according to a modification example of the first embodiment,

FIG. 17 is a block diagram illustrating an example of a configuration of a third arithmetic module,

FIG. 18 is a diagram illustrating a third convolution process,

FIG. 19 is a diagram conceptually illustrating the first to third feature amount extraction processes,

FIG. 20 is a block diagram illustrating an example of a configuration of a feature amount extraction unit according to a second embodiment,

FIG. 21 is a block diagram illustrating an example of a configuration of a plurality of arithmetic modules comprised in a decoder,

FIG. 22 is a diagram conceptually illustrating a hierarchical structure of a CNN composed of an encoder and the decoder, and

FIG. 23 is a diagram illustrating pipeline processing performed on a feature map.

### DETAILED DESCRIPTION

Examples of embodiments according to the technology of the present disclosure will be described with reference to the accompanying drawings.

First, the wording used in the following description will be described.

In the following description, “IC” is an abbreviation for “Integrated Circuit”. “DRAM” is an abbreviation for “Dynamic Random Access Memory”. “FPGA” is an abbreviation for “Field Programmable Gate Array”. “PLD” is an abbreviation for “Programmable Logic Device”. “ASIC” is an abbreviation for “Application Specific Integrated Circuit”. “CNN” is an abbreviation for “Convolutional Neural Network”. “ALU” is an abbreviation for “Arithmetic Logic Unit”.

### First Embodiment

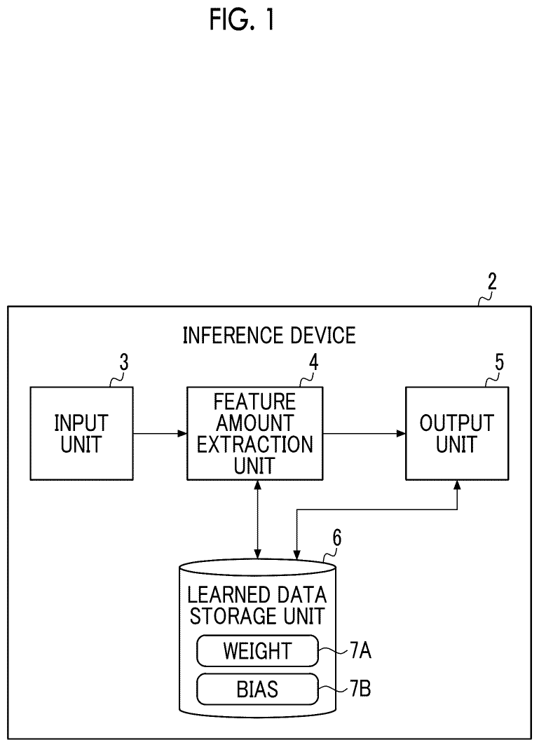

FIG. 1 illustrates an example of a configuration of an inference device 2. For example, the inference device 2 is incorporated into an imaging apparatus such as a digital camera. The inference device 2 is a device that performs inference using machine learning and calculates, for example, the type of an object included in image data using inference. The imaging apparatus performs various types of control related to imaging on the basis of an inference result output from the inference device 2.

The inference device 2 comprises an input unit 3, a feature amount extraction unit 4, an output unit 5, and a learned data storage unit 6. The input unit 3 acquires image data generated by imaging performed by the imaging apparatus and inputs the acquired image data as input data to the feature amount extraction unit 4. The feature amount extraction unit 4 and the output unit 5 constitute a so-called convolutional neural network (CNN). A weight 7A and a bias 7B are stored in the learned data storage unit 6. The weight 7A and the bias 7B are machine-learned data generated by machine learning.

The feature amount extraction unit 4 is a middle layer including a plurality of convolutional layers and pooling layers. In this embodiment, the output unit 5 is an output layer configured to include a fully connected layer.

The feature amount extraction unit 4 executes a convolution process and a pooling process on the image data input from the input unit 3 to extract a feature amount. The output unit 5 classifies the image data input to the inference device 2 on the basis of the feature amount extracted by the feature amount extraction unit 4. For example, the output unit 5 classifies the type of the object included in the image data. The feature amount extraction unit 4 and the output unit 5 perform a feature amount extraction process and a classification process using a trained model that is configured using the weight 7A and the bias 7B stored in the learned data storage unit 6. The feature amount extraction process is an example of “arithmetic processing” according to the technology of the present disclosure.

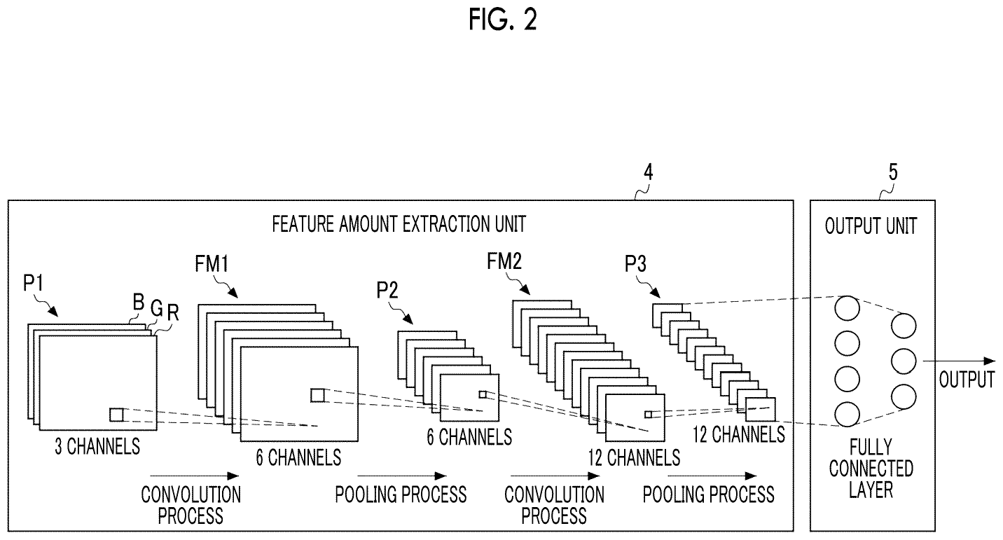

FIG. 2 conceptually illustrates an example of the feature amount extraction process and the classification process. As illustrated in FIG. 2, image data P1 input from the input unit 3 to the feature amount extraction unit 4 is composed of three channels of red (R), green (G), and blue (B). The feature amount extraction unit 4 repeatedly executes the convolution process and the pooling process on the input image data P1 a plurality of times. The image data P1 is an example of “first image data” according to the technology of the present disclosure.

The feature amount extraction unit 4 executes the convolution process on the image data P1 of three channels to generate a feature map FM1 of six channels and executes the pooling process on the generated feature map FM1 to generate image data P2. The image data P1 and the image data P2 have different numbers of channels. The number of channels of the image data P2 is larger than the number of channels of the image data P1. The image data P2 has a smaller number of pixels (that is, a smaller image size) than the image data P1. In addition, the image data P2 is image data including the feature amount generated by the execution of the feature amount extraction process on the image data P1 by a first arithmetic module 11. The image data P2 is an example of “second image data” according to the technology of the present disclosure.

In addition, the feature amount extraction unit 4 executes the convolution process on the image data P2 to generates a feature map FM2 of 12 channels and executes the pooling process on the generated feature map FM2 to generate image data P3. The image data P2 and the image data P3 have different numbers of channels. The number of channels of the image data P3 is larger than the number of channels of the image data P2. The image data P3 has a smaller number of pixels (that is, a smaller image size) than the image data P2. In addition, the image data P3 is image data including the feature amount generated by the execution of the feature amount extraction process on the image data P2 by a second arithmetic module 12.

In the example illustrated in FIG. 2, the image data P3 is input from the feature amount extraction unit 4 to the output unit 5. The output unit 5 is configured to include a fully connected layer and classifies the image data P1 on the basis of the image data P3 including the feature amount. The output unit 5 outputs the result of classifying the image data P1 as an inference result.

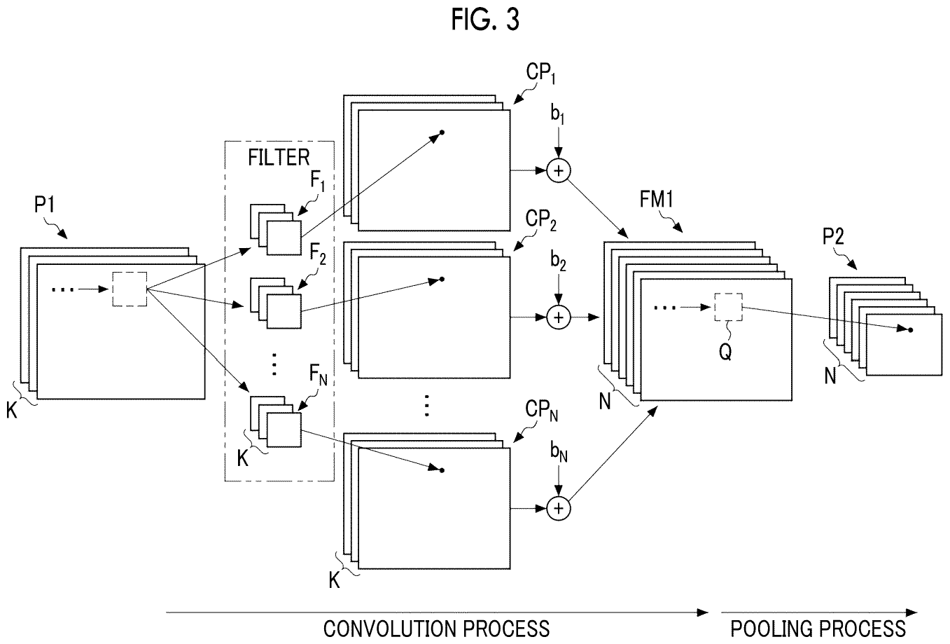

FIG. 3 illustrates the convolution process and the pooling process in detail. In FIG. 3, the number of channels of the image data P1 is K. The feature amount extraction unit 4 executes a convolution operation on the image data P1 as the input data using N filters F₁ to F_{N} to generate N image data items CP₁ to CP_{N}. The filters F₁ to F_{N} are configured by the weight 7A. The number of channels of each of the image data items CP₁ to CP_{N} is K.

Further, the feature amount extraction unit 4 integrates the channels of each of the image data items CP₁ to CP_{N} and then adds biases b₁ to b_{N} to each of the image data items CP₁ to CP_{N} to generate the feature map FM1. In addition, the integration of the channels means adding corresponding pixel values of a plurality of channels to convert the plurality of channels into one channel. The number of channels of the feature map FM1 is N. Further, the biases b₁ to b_{N} correspond to the bias 7B.

Furthermore, the feature amount extraction unit 4 executes the pooling process on the feature map FM1 using, for example, a 2×2 kernel Q to generate the image data P2. The pooling process is, for example, a maximum pooling process of acquiring the maximum value of pixel values of the kernel Q. Instead of the maximum pooling process, an average pooling process of acquiring the average values of the pixel values of the kernel Q may be used. In a case in which the 2×2 kernel Q is used, the number of pixels of the image data P2 is 1/4 of the number of pixels of the image data P1.

In addition, the feature amount extraction unit 4 applies an activation function in the convolution process or the pooling process. In FIG. 3, the application of the activation function is not illustrated.

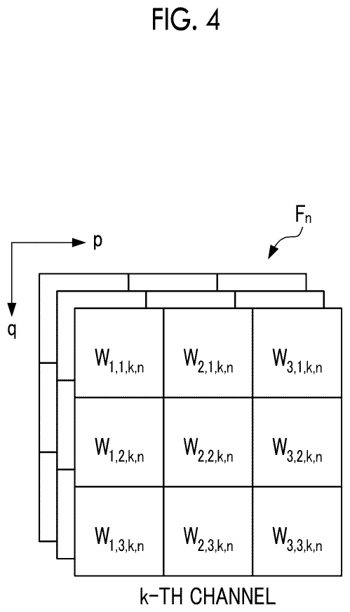

FIG. 4 illustrates a configuration of a k-th channel of a filter Fₙ. The filter Fₙ is one filter among the N filters F₁ to F_{N}. In the example illustrated in FIG. 4, the filter Fₙ has a size of 3×3 and K channels. The k-th channel of the filter Fₙ is represented by nine weights w_{p, q, k, n}. Here, p indicates a coordinate in the horizontal direction in the filter Fₙ and q indicates a coordinate in the vertical direction in the filter Fₙ. The weight w_{p, q, k, n} corresponds to the weight 7A. In addition, the size of the filter Fₙ is not limited to 3×3 and can be appropriately changed to, for example, a size of 5×5.

The convolution process is represented by the following Expression 1.

$$[ Equation 1 ]$$

$${c}_{x , y , n} = {\sum }_{p , q , k} {w}_{p , q , k , n} {a}_{x + p , y + q , k} + {b}_{n} \qquad ( 1 )$$

In Expression 1, a_{x+p, y+q, k} indicates a pixel value of a pixel multiplied by the weight w_{p, q, k, n} in the k-th channel of the image data P1. x and y indicate coordinates in the feature map FM1. c_{x, y, n} indicates a pixel value of a pixel at the coordinates x and y in an n-th channel of the feature map FM1. bₙ indicates a bias added to each pixel of the n-th channel of the feature map FM1.

In addition, in a case where the feature amount extraction unit 4 performs the convolution process and the pooling process on the image data P2, the feature amount extraction unit 4 performs the same process, using the image data P2 as the input data, instead of the image data P1.

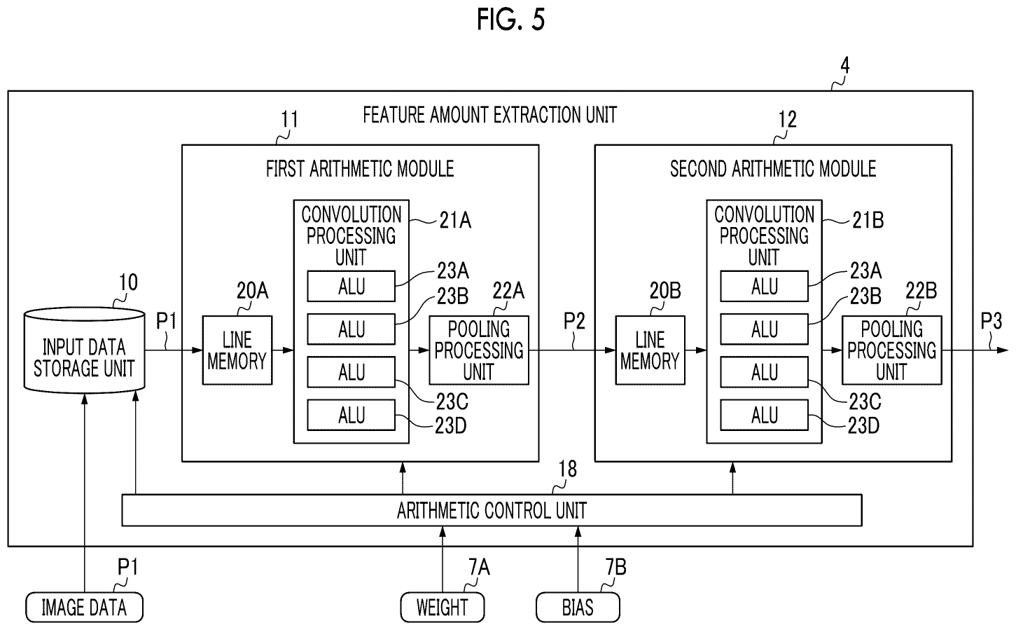

FIG. 5 illustrates an example of a configuration of the feature amount extraction unit 4. The feature amount extraction unit 4 comprises an input data storage unit 10, the first arithmetic module 11, a second arithmetic module 12, and an arithmetic control unit 18. The input data storage unit 10 stores the image data P1 input from the input unit 3. The first arithmetic module 11 comprises a line memory 20A, a convolution processing unit 21A, and a pooling processing unit 22A. In addition, the pooling processing unit 22A may be provided for each of ALUs 23A to 23D.

The second arithmetic module 12 comprises a line memory 20B, a convolution processing unit 21B, and a pooling processing unit 22B. The pooling processing unit 22B may be provided for each of ALUs 23A to 23D.

The arithmetic control unit 18 controls the operations of the input data storage unit 10, the first arithmetic module 11, and the second arithmetic module 12. The first arithmetic module 11 performs the feature amount extraction process on the image data P1 to generate the image data P2. The second arithmetic module 12 performs the feature amount extraction process on the image data P2 to generate the image data P3. The first arithmetic module 11 and the second arithmetic module 12 perform pipeline processing to execute the feature amount extraction process in parallel. Specifically, the feature amount extraction process of the second arithmetic module 12 on the data processed by the first arithmetic module 11 and the feature amount extraction process of the first arithmetic module 11 on the next data are executed in parallel.

The convolution processing unit 21A includes a plurality of ALUs that perform the convolution operation. In this embodiment, the convolution processing unit 21A comprises four ALUs 23A to 23D. The ALUs 23A to 23D execute the convolution process on the input data in parallel, which will be described in detail below.

Similarly, the convolution processing unit 21B includes a plurality of ALUs that perform the convolution operation. In this embodiment, the convolution processing unit 21B comprises four ALUs 23A to 23D. The ALUs 23A to 23D execute the convolution process on the input data in parallel, which will be described in detail below.

Further, the ALUs 23A to 23D included in the convolution processing unit 21A of the first arithmetic module 11 are an example of “a plurality of first arithmetic units” according to the technology of the present disclosure. The ALUs 23A to 23D included in the convolution processing unit 21B of the second arithmetic module 12 are an example of “a plurality of second arithmetic units” according to the technology of the present disclosure.

The arithmetic control unit 18 divides the image data P1 stored in the input data storage unit 10 for each first number of pixels G1 in a row direction to generate a plurality of strip data items (hereinafter, referred to as first strip data items PS1). In addition, the arithmetic control unit 18 sequentially stores a plurality of first row data items R1 included in the first strip data PS1 in the line memory 20A of the first arithmetic module 11. The ALUs 23A to 23D of the first arithmetic module 11 execute the convolution process on the plurality of first row data items R1. In addition, the first row data R1 is data corresponding to some rows of the image data P1.

In addition, the arithmetic control unit 18 sequentially stores a plurality of second row data items R2 constituting the image data P2 output from the first arithmetic module 11 in the line memory 20B of the second arithmetic module 12. The plurality of second row data items R2 are included in a plurality of strip data items (hereinafter, referred to as second strip data items PS2) generated by dividing the image data P2 for each second number of pixels G2 in the row direction. The ALUs 23A to 23D of the second arithmetic module 12 execute the convolution process on the plurality of second row data items R2.

Hereinafter, the convolution process performed by the first arithmetic module 11 is referred to as a “first convolution process”, and the convolution process performed by the second arithmetic module 12 is referred to as a “second convolution process”. In addition, the line memory 20A is an example of a “first memory” according to the technology of the present disclosure. The line memory 20B is an example of a “second memory” according to the technology of the present disclosure. The number of filters used in the second convolution process is larger than the number of filters used in the first convolution process.

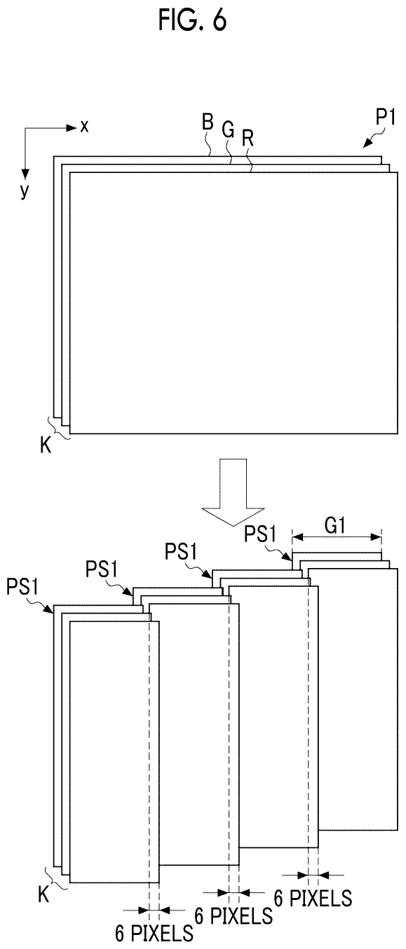

FIG. 6 illustrates an example of the process of dividing the image data P1 by the arithmetic control unit 18. The image data P1 has pixels that are two-dimensionally arranged in an x direction and a y direction for each of R, G, and B channels. As illustrated in FIG. 6, for example, the arithmetic control unit 18 divides the image data P1 into four portions in the x direction (corresponding to the row direction) to generate four first strip data items PS1. The width of the first strip data PS1 in the x direction corresponds to the first number of pixels G1.

Further, in this embodiment, the arithmetic control unit 18 divides the image data P1 such that end portions of the first strip data items PS1 adjacent to each other in the x direction overlap each other. In this embodiment, since the convolution process using the filter having a size of 3×3 is performed twice, the width of the overlap is 6 pixels. It is preferable to change the width of the overlap depending on the size of the filter and the number of times of the convolution process is performed.

In a case where the convolution process is performed without dividing the image data P1, it is necessary to increase a memory bandwidth in order to store multi-channel data generated by the convolution process in a large-capacity memory (DRAM or the like). However, in an imaging apparatus such as a battery-driven digital camera, since it is not easy to achieve a fast memory bandwidth, the memory bandwidth is a bottleneck in the process. On the other hand, as described above, the division of the image data P1 makes it possible to perform the convolution process using a small-capacity line memory. Therefore, the bottleneck caused by the memory bandwidth does not occur, and the processing speed is increased.

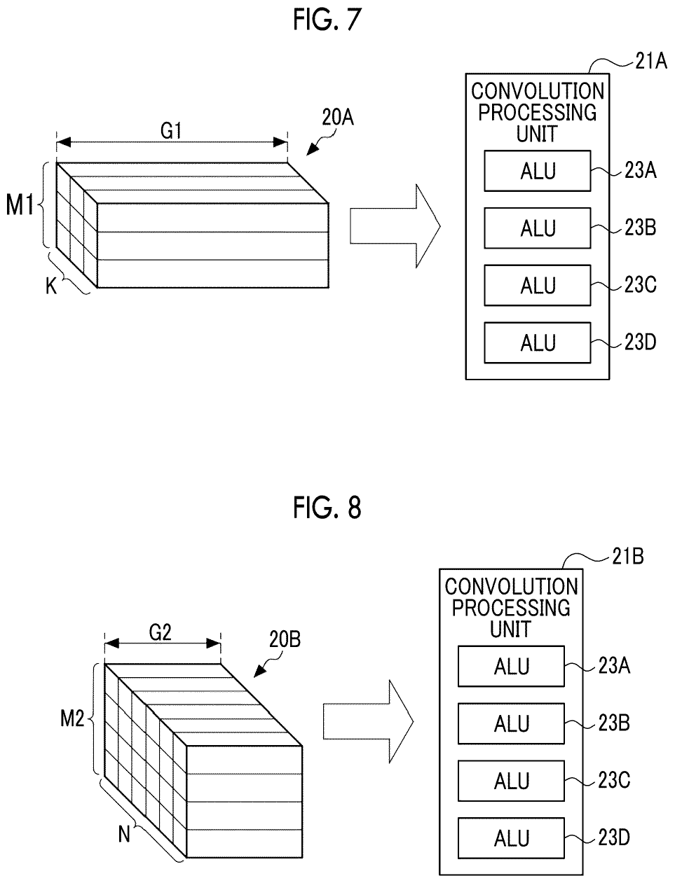

FIG. 7 illustrates an example of a configuration of the line memory 20A. The unit of data storage in the line memory 20A corresponds to the first number of pixels G1, the size of the filter used in the first convolution process, and the number of channels K of the filter used in the first convolution process. In FIG. 7, M1 indicates the number of lines for each channel. The number of lines M1 is determined according to the size of the filter. In this embodiment, K is 3, and M1 is 3.

The first row data R1 is stored in units of M1×K in the line memory 20A. The first row data R1 is sequentially input from the line memory 20A to the convolution processing unit 21A. The first row data R1 means data of a line, in which pixels corresponding to one channel are arranged in the x direction, in the first strip data PS1.

FIG. 8 illustrates an example of a configuration of the line memory 20B. The unit of data storage in the line memory 20B corresponds to the second number of pixels G2, the size of the filter used in the second convolution process, and the number of channels N of the filter used in the second convolution process. In FIG. 8, M2 indicates the number of lines for each channel. The number of lines M2 is determined according to the size of the filter. In this embodiment, N is 6, and M2 is 4. Further, the second number of pixels G2 is 1/2 of the first number of pixels G1. This is due to the fact that the number of pixels in the x direction is halved by the pooling process of the first arithmetic module 11.

The second row data R2 is stored in units of M2×N in the line memory 20B. The second row data R2 is sequentially input from the line memory 20B to the convolution processing unit 21B. The second row data R2 means data of a line, in which pixels corresponding to one channel are arranged in the x direction, in the second strip data PS2.

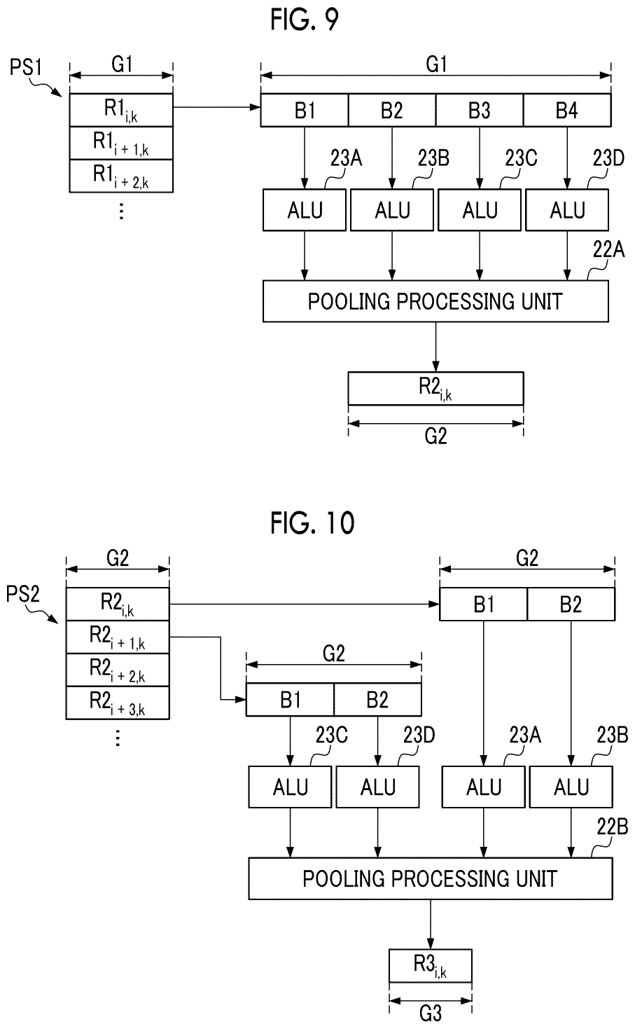

FIG. 9 illustrates the first convolution process. In FIG. 9, R1_{i, k} indicates i-th first row data of a k-th channel read out from the line memory 20A. The first row data R1_{i, k} is divided into four blocks B1 to B4, and the four blocks B1 to B4 are input to the ALUs 23A to 23D, respectively. The width of each of the blocks B1 to B4 corresponds to the number of pixels that is 1/4 of the first number of pixels G1.

Each of the ALUs 23A to 23D multiplies the input block by a weight while shifting the pixel to execute the first convolution process. The ALUs 23A to 23D execute the first convolution process once on three first row data items R1_{i, k}, R1_{i+1, k}, and R1_{i+2, k} in parallel. That is, in the first arithmetic module 11, the number of first arithmetic units (hereinafter, referred to as a first number) that execute the first convolution process once on a plurality of first row data items R1 in parallel is “4”.

Data output from the ALUs 23A to 23D is input to the pooling processing unit 22A. The pooling processing unit 22A performs a 2×2 pooling process and outputs the second row data R2_{i, k} having the width of the second number of pixels G2. A plurality of second row data items R2_{i, k} output from the pooling processing unit 22A constitute the second strip data PS2. The image data P2 is composed of a plurality of second strip data items PS2.

FIG. 10 illustrates the second convolution process. In FIG. 10, R2_{i, k} indicates i-th second row data of the k-th channel read out from the line memory 20B. The i-th second row data R2_{i, k} is divided into two blocks B1 and B2, and the two blocks B1 and B2 are input to the ALUs 23A and 23B, respectively. At the same time, (i+1)-th second row data R2_{i+1, k} is divided into two blocks B1 and B2, and the two blocks B1 and B2 are input to the ALUs 23C and 23D, respectively. The width of each of the blocks B1 and B2 corresponds to the number of pixels that is 1/2 of the second number of pixels G2.

Each of the ALUs 23A to 23D multiplies the input block by a weight while shifting the pixel to execute the second convolution process. The ALUs 23A and 23B execute the second convolution process once on three second row data items R2_{i, k}, R2_{i+1, k}, and R2_{i+2, k} in parallel. At the same time, the ALUs 23C and 23D execute the second convolution process once on three second row data items R2_{i+1, k}, R2_{i+2, k}, and R2_{i+3, k} in parallel. That is, in the second arithmetic module 12, the number of second arithmetic units (hereinafter, referred to as a second number) that execute the second convolution process once on a plurality of second row data items R2 in parallel is “2”. That is, the first number and the second number are different from each other. In this embodiment, the first number is larger than the second number.

Data output from the ALUs 23A to 23D is input to the pooling processing unit 22B. The pooling processing unit 22B performs a 2×2 pooling process and outputs third row data R3_{i, k} having the width of a third number of pixels G3. A plurality of third row data items R3_{i, k} output from the pooling processing unit 22B constitute third strip data PS3. The image data P3 is composed of a plurality of third strip data items PS3. The third number of pixels G3 is 1/2 of the second number of pixels G2.

The first arithmetic module 11 executes the process on one first row data item R1 using the ALUs 23A to 23D at the same time. On the other hand, the second arithmetic module 12 executes the process on two adjacent second row data items R2 using the ALUs 23A to 23D at the same time. The number of pixels processed in the image data P2 input to the second arithmetic module 12 is smaller than the number of pixels processed in the image data P1 input to the first arithmetic module 11. The number of pixels processed means the number of pixels processed by the arithmetic module.

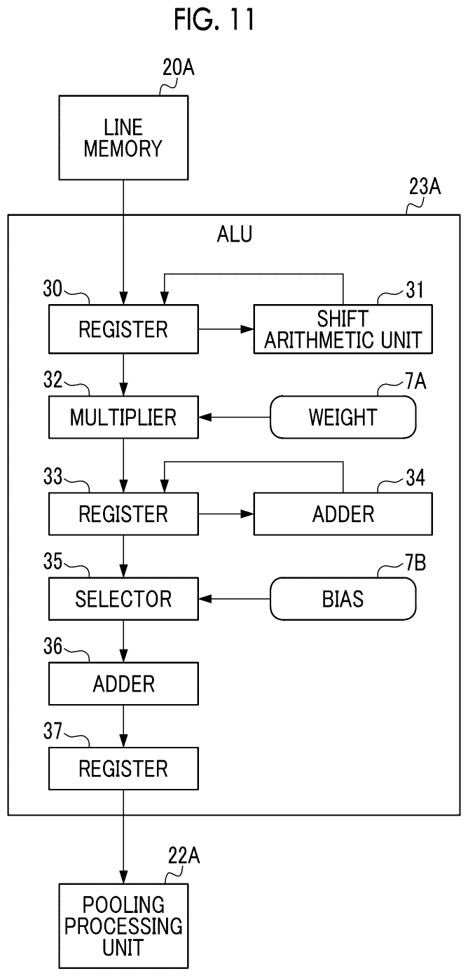

FIG. 11 illustrates an example of a configuration of the ALU 23A. The ALU 23A is configured to include a register 30, a shift arithmetic unit 31, a multiplier 32, a register 33, an adder 34, a selector 35, an adder 36, and a register 37.

The block B1 is input to the register 30. The multiplier 32 multiplies each pixel of the block B1 input to the register 30 by the weight 7A. The block B1 multiplied by the weight 7A is input to the register 33.

The shift arithmetic unit 31 shifts the block B1 stored in the register 30 by one pixel each time the multiplier 32 multiplies the weight 7A. The multiplier 32 multiplies each pixel of the block B1 by the weight 7A each time the pixel of the block B1 is shifted. The adder 34 sequentially adds each pixel of the block B1 input to the register 33.

The above-described multiplication and addition process is repeated the number of times corresponding to the size of the filter and the number of channels. For example, in a case where the size of the filter is 3×3 and the number of channels is 3, the multiplication and addition process is repeated 27 times.

The selector 35 selects the bias 7B corresponding to the filter. The adder 36 adds the bias 7B selected by the selector 35 to the data after addition that is stored in the register 33. The register 37 stores data to which the bias 7B has been added. The data stored in the register 37 is output to the pooling processing unit 22A.

Since the ALUs 23B to 23D have the same configuration as the ALU 23A, a description thereof will not be repeated.

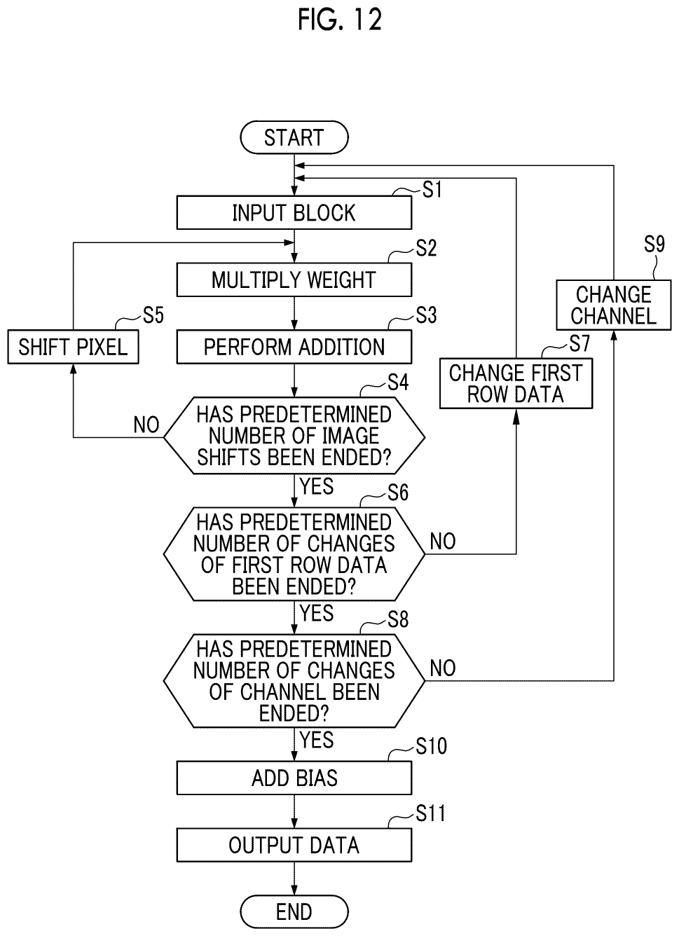

FIG. 12 illustrates an example of a flow of the first convolution process performed once by the ALU 23A. In Step S1, the block B1 divided from one first row data item R1 is input to the register 30. In Step S2, the multiplier 32 performs a process of multiplying the weight 7A. In Step S3, the adder 34 performs the addition process for each pixel. In Step S4, it is determined whether or not a predetermined number of pixel shifts have been ended. In a case where the size of the filter is 3×3, the pixel shift is performed twice. Therefore, the predetermined number of pixel shifts is 2. In a case where the predetermined number of pixel shifts have not been ended (Step S4: NO), the pixel shift is performed in Step S5. Steps S2 to S5 are repeatedly executed until the pixel shift is performed the predetermined number of times. In a case where the predetermined number of pixel shifts have been ended (Step S4: YES), the process proceeds to Step S6.

In Step S6, it is determined whether or not a predetermined number of changes of the first row data R1 have been ended. In a case where the size of the filter is 3×3, the first row data R1 is changed twice. Therefore, the predetermined number of changes is 2. In a case where the predetermined number of changes of the first row data R1 have not been ended (Step S6: NO), the first row data R1 is changed in Step S7. In a case where the block B1 is changed, the block B1 divided from the changed first row data R1 is input to the register 30 in Step S1. Steps S1 to S7 are repeatedly executed until the first row data R1 is changed the predetermined number of times. In a case where the predetermined number of changes of the first row data R1 have been ended (Step S6: YES), the process proceeds to Step S8.

In Step S8, it is determined whether or not a predetermined number of changes of the channel have been ended. In a case where a three-channel filter is used, the channel is changed twice. Therefore, the predetermined number of changes is 2. In a case in which the predetermined number of changes of the channel have not been ended (Step S8: NO), the channel is changed in Step S9. In a case where the channel is changed, the block B1 of the changed channel is input to the register 30 in Step S1. Steps S1 to S9 are repeatedly executed until the channel is changed the predetermined number of times. In a case where the predetermined number of changes of the channel have been ended (Step S8: YES), the process proceeds to Step S10.

In Step S10, the adder 36 performs the process of adding the bias 7B. In Step S11, data, to which the bias 7B has been added, is output to the pooling processing unit 22A.

The process illustrated in FIG. 12 indicates the first convolution process performed once on three first row data items R1 included in the first strip data PS1. The ALU 23A executes the first convolution process while sequentially changing the three target first row data items R1.

The ALUs 23B to 23D perform the same process as the ALU 23A.

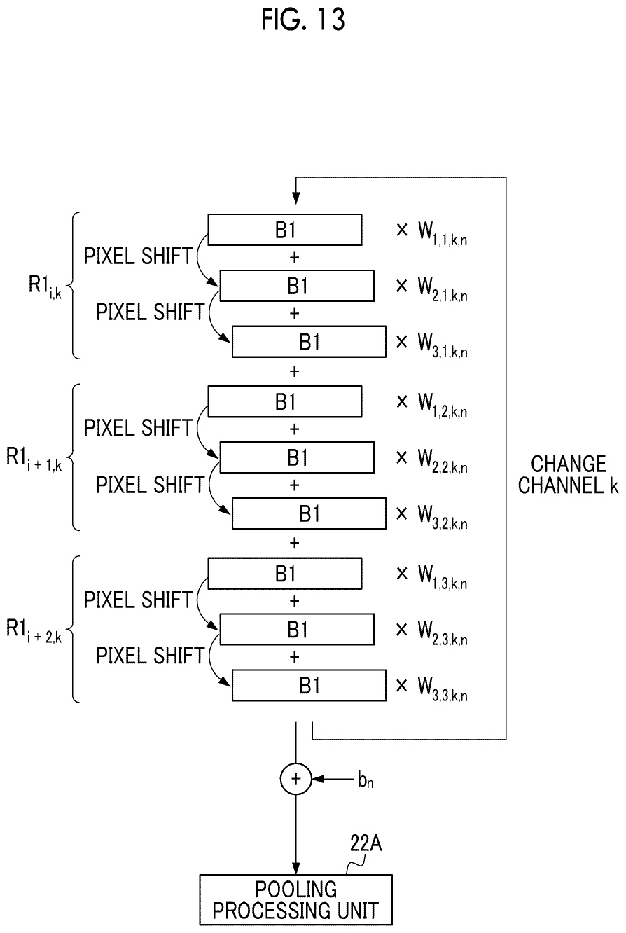

FIG. 13 conceptually illustrates the first convolution process performed once by the ALU 23A. As illustrated in FIG. 13, the ALU 23A multiplies the blocks B1 divided from three first row data items R1_{i, k}, R1_{i+1, k}, and R1_{i+2, k} by corresponding weights w_{p, q, k, n} while sequentially shifting pixels and adds the blocks 1. One block constituting image data CPₙ is obtained by performing the pixel shift, the multiplication of the weight, and the addition on all of the channels k and adding the bias bₙ.

In the first arithmetic module 11, the ALUs 23A to 23D perform the first convolution process while changing a set of three target first row data items R1_{i, k}, R1_{i+1, k}, and R1_{i+2, k} by one row.

In the second arithmetic module 12, the ALUs 23A and 23B perform the second convolution process while changing a set of three target second row data items R2_{i, k}, R2_{i+1, k}, and R2_{i+2, k} by two rows. Further, the ALUs 23A and 23B perform the second convolution process while changing a set of three target second row data items R2_{i+1, k}, R2_{i+2, k}, and R2_{i+3, k} by two rows.

Since the second convolution process is the same as the first convolution process, a detailed description thereof will not be repeated.

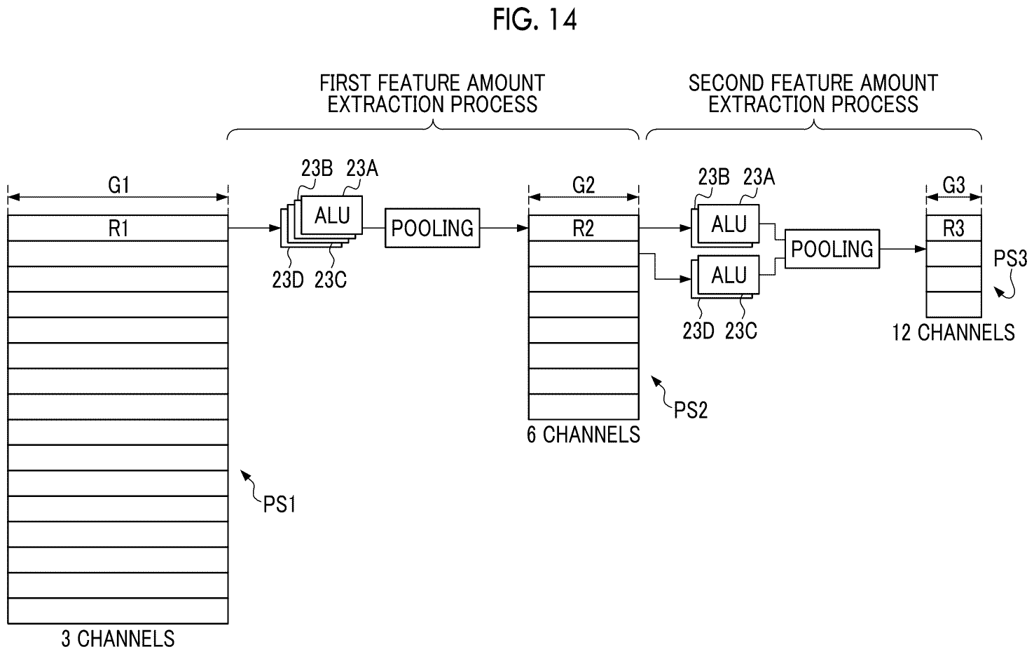

FIG. 14 conceptually illustrates a first feature amount extraction process and a second feature amount extraction process. In the example illustrated in FIG. 14, in the second strip data PS2 generated by performing the first feature amount extraction process on the first strip data PS1, the number of pixels in each of the vertical and horizontal directions is halved, and the number of channels is doubled. In addition, in the third strip data PS3 generated by performing the second feature amount extraction process on the second strip data PS2, the number of pixels in each of the vertical and horizontal directions is halved, and the number of channels is doubled.

As described above, the second number of pixels G2 of the second row data R2 generated by the first feature amount extraction process is 1/2 of the first number of pixels G1 of the first row data R1. Therefore, in a case where the first arithmetic module 11 and the second arithmetic module 12 have the same configuration such that one second row data item R2 is processed by four ALUs, two of the four ALUs are not used and are wasted in the second arithmetic module 12. In this embodiment, the first arithmetic module 11 is configured such that one first row data item R1 is processed by four ALUs, and the second arithmetic module 12 is configured such that one second row data item R2 is processed by two ALUs. Therefore, there are no unnecessary ALUs that are not used.

In addition, the number of channels processed in the second feature amount extraction process is larger than that in the first feature amount extraction process. Therefore, until the second feature amount extraction process is performed on all of the channels, waiting for the first feature amount extraction process occurs. Specifically, after outputting data corresponding to one row to the second arithmetic module 12, the first arithmetic module 11 is not capable of outputting data corresponding to the next row unless the second feature amount extraction process on all of the channels is ended. Therefore, the waiting for the process occurs. In contrast, in this embodiment, the second arithmetic module 12 processes the data of two rows at the same time using two ALUs. Therefore, the second feature amount extraction process can be performed at a higher speed than the first feature amount extraction process. Therefore, the waiting for the first feature amount extraction process is eliminated.

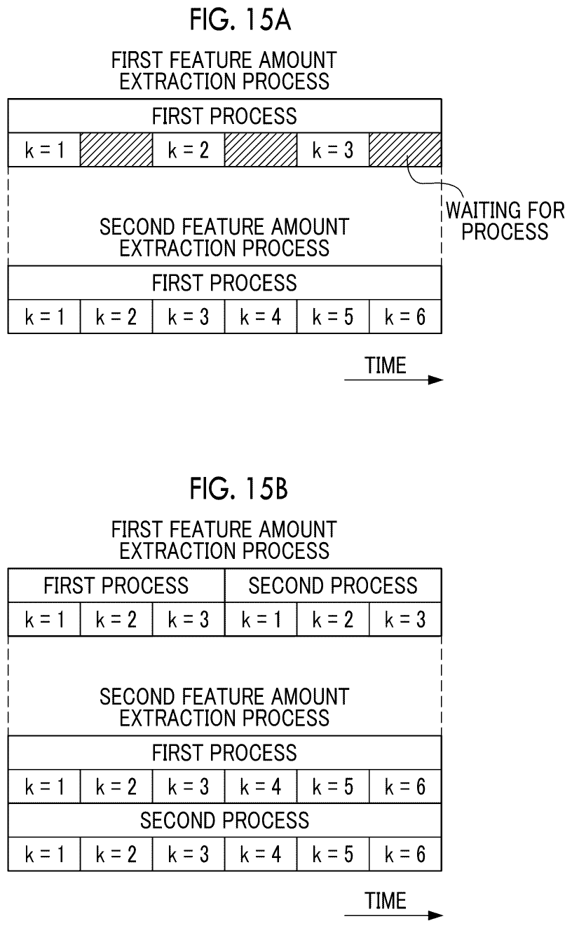

FIGS. 15A and 15B illustrate timings of the first feature amount extraction process and the second feature amount extraction process. FIG. 15A illustrates an example of a processing timing in a case where the first arithmetic module 11 and the second arithmetic module 12 are configured to process one row data item with four ALUs. A first process indicates a process on a set of three row data items. In this case, the time required for the first process in the first feature amount extraction process is shorter than that in the second feature amount extraction process. Therefore, the waiting for the first feature amount extraction process occurs.

FIG. 15B illustrates an example of a processing timing in a case where the first arithmetic module 11 is configured to process one row data item with four ALUs and the second arithmetic module 12 is configured to process one row data item with two ALUs. The first process indicates a process on a set of three row data items. A second process indicates a process on the next set of three row data items shifted by one row. In this case, the time required for the first process and the second process in the first feature amount extraction process is shorter than that in the second feature amount extraction process. However, since the first process and the second process are performed in parallel in the second feature amount extraction process, the waiting for the first feature amount extraction process is eliminated.

As described above, in this embodiment, since the waiting for the first feature amount extraction process is eliminated, the processing speed related to the inference by the inference device 2 is increased.

### Modification Examples of First Embodiment

In the first embodiment, the feature amount extraction unit 4 includes two arithmetic modules of the first arithmetic module 11 and the second arithmetic module 12. However, the number of arithmetic modules is not limited to two and may be three or more.

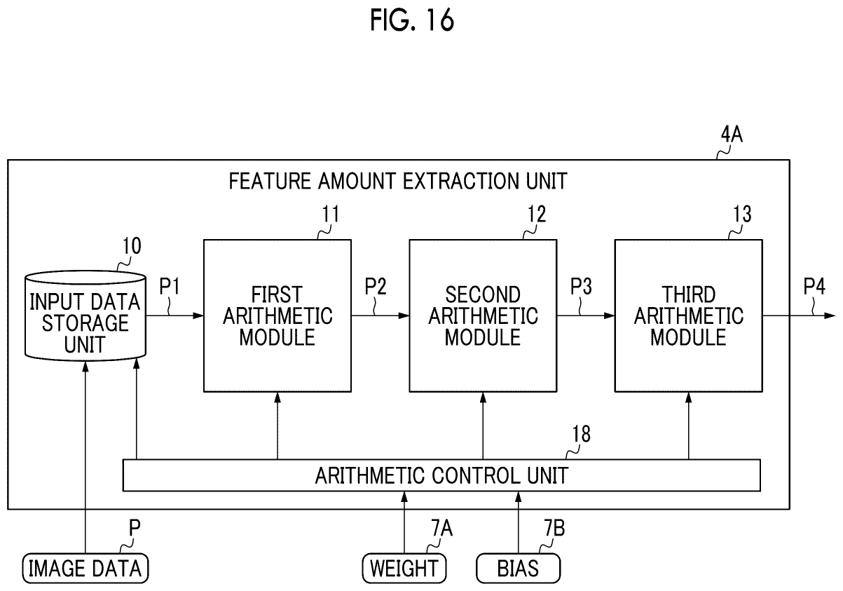

FIG. 16 illustrates a configuration of a feature amount extraction unit 4A according to a modification example. The feature amount extraction unit 4A has the same configuration as the feature amount extraction unit 4 according to the first embodiment except that it includes a third arithmetic module 13 in addition to the first arithmetic module 11 and the second arithmetic module 12.

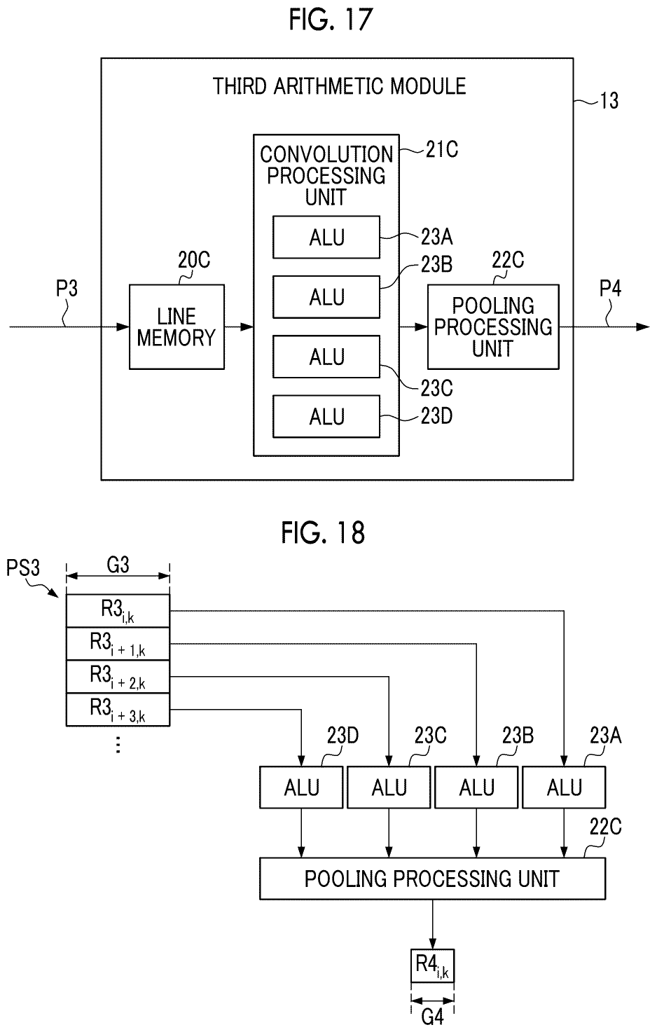

FIG. 17 illustrates an example of a configuration of the third arithmetic module 13. Similarly to the first arithmetic module 11 and the second arithmetic module 12, the third arithmetic module 13 comprises a line memory 20C, a convolution processing unit 21C, and a pooling processing unit 22C. In addition, the convolution processing unit 21C comprises four ALUs 23A to 23D. Further, the pooling processing unit 22C may be provided for each of the ALUs 23A to 23D.

The arithmetic control unit 18 sequentially stores a plurality of third row data items R3 constituting the image data P3 output from the second arithmetic module 12 in the line memory 20C of the third arithmetic module 13. The plurality of third row data items R3 are included in a plurality of third strip data items PS3 generated by dividing the image data P3 for each third number of pixels G3 in the row direction.

The ALUs 23A to 23D of the third arithmetic module 13 execute the convolution process on the plurality of third row data items R3. Hereinafter, the convolution process performed by the third arithmetic module 13 is referred to as a “third convolution process”.

FIG. 18 illustrates the third convolution process. In FIG. 18, R3_{i, k} indicates i-th third row data of a k-th channel read out from the line memory 20C. The i-th third row data R3_{i, k} is input to the ALU 23A. (i+1)-th third row data R3_{i+1, k} is input to the ALU 23B. (i+2)-th third row data R3_{i+2, k} is input to the ALU 23C. (i+3)-th third row data R3_{i+3, k} is input to the ALU 23D.

Each of the ALUs 23A to 23D multiplies the input third row data R3 by a weight while shifting the pixel to execute the third convolution process. The ALU 23A executes the third convolution process once on three third row data items R3_{i, k}, R3_{i+1, k}, and R3_{i+2, k} in parallel. The ALU 23B executes the third convolution process once on three third row data items R3_{i+1, k}, R3_{i+2, k}, and R3_{i+3, k} in parallel. The ALU 23C executes the third convolution process once on three third row data items R3_{i+2, k}, R3_{i+3, k}, and R3_{i+4, k} in parallel. The ALU 23D executes the third convolution process once on three third row data items R3_{i+3, k}, R3_{i+4, k}, and R3_{i+5, k} in parallel.

Since the third convolution process is the same as the first convolution process and the second convolution process, a detailed description thereof will not be repeated.

Data output from the ALUs 23A to 23D is input to the pooling processing unit 22C. The pooling processing unit 22C performs a 2×2 pooling process and outputs fourth row data R4_{i, k} having the width of a fourth number of pixels G4. A plurality of fourth row data items R4_{i, k} output from the pooling processing unit 22C constitute fourth strip data PS4. The image data P4 is composed of a plurality of fourth strip data items PS4. The fourth number of pixels G4 is 1/2 of the third number of pixels G3. In addition, the image data P4 has a larger number of channels than the image data P3.

In this modification example, the third arithmetic module 13 outputs the image data P4 to the output unit 5. The output unit 5 classifies the image data P1 on the basis of the image data P4 including a feature amount.

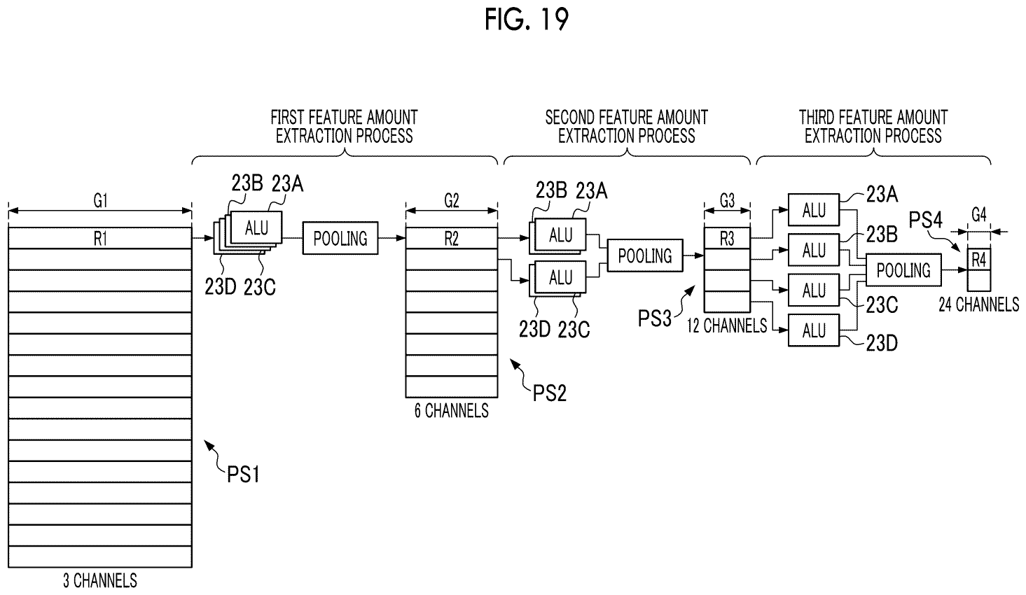

FIG. 19 conceptually illustrates the first to third feature amount extraction processes. In the example illustrated in FIG. 19, in the second strip data PS2 generated by performing the first feature amount extraction process on the first strip data PS1, the number of pixels in each of the vertical and horizontal directions is halved, and the number of channels is doubled. In addition, in the third strip data PS3 generated by performing the second feature amount extraction process on the second strip data PS2, the number of pixels in each of the vertical and horizontal directions is halved, and the number of channels is doubled. Further, in the fourth strip data PS4 generated by performing the third feature amount extraction process on the third strip data PS3, the number of pixels in each of the vertical and horizontal directions is halved, and the number of channels is doubled.

### Second Embodiment

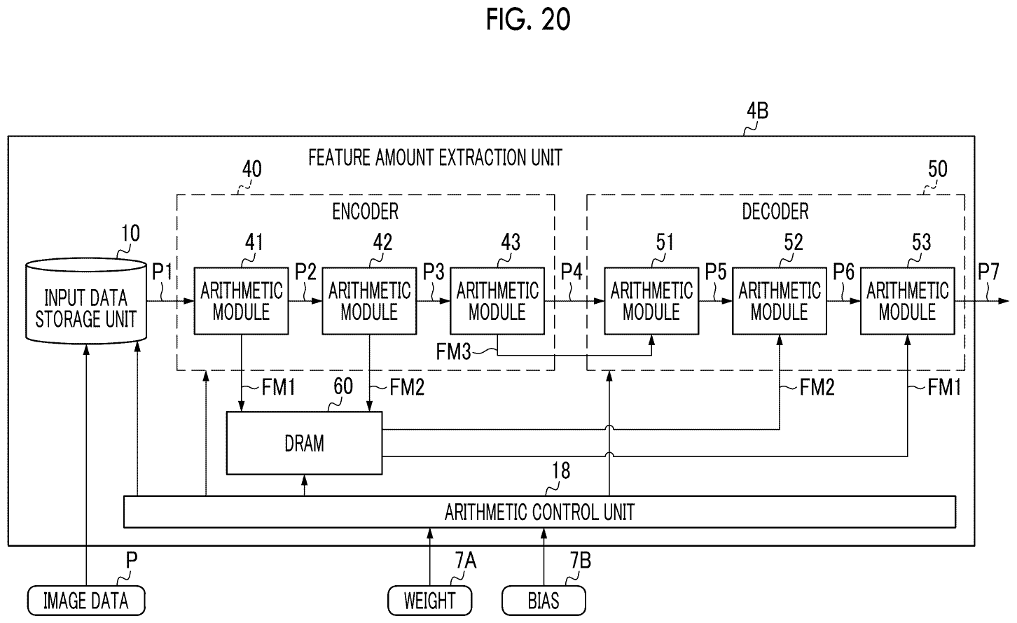

Next, a second embodiment of the present disclosure will be described. An inference device according to the second embodiment uses a feature amount extraction unit 4B illustrated in FIG. 20 instead of the feature amount extraction unit 4. The feature amount extraction unit 4B according to this embodiment constitutes a CNN used for object detection and/or region extraction. For example, the feature amount extraction unit 4B constitutes a so-called U-Net. In this embodiment, since the inference device performs object detection and/or region extraction instead of classification, image data is output from the output unit 5.

As illustrated in FIG. 20, the feature amount extraction unit 4B comprises an input data storage unit 10, an encoder 40, a decoder 50, a DRAM 60, and an arithmetic control unit 18. The encoder 40 comprises three arithmetic modules 41 to 43. The decoder 50 comprises three arithmetic modules 51 to 53. The number of arithmetic modules provided in each of the encoder 40 and the decoder 50 is not limited to three and may be two or four or more.

As in the first embodiment, the encoder 40 repeatedly executes the convolution process and the pooling process on image data P1 as input data a plurality of times. The arithmetic modules 41 to 43 have the same configurations as the first arithmetic module 11, the second arithmetic module 12, and the third arithmetic module 13. Each time the arithmetic modules 41 to 43 sequentially perform the convolution process and the pooling process, an image size is reduced, and the number of channels is increased. The pooling process is also referred to as a downsampling process because the image size is reduced.

The decoder 50 repeatedly executes an upsampling process and a deconvolution process on image data P4 output by the encoder 40 a plurality of times. The arithmetic modules 51 to 53 are configured to execute the deconvolution process and the upsampling processing unlike the arithmetic modules 41 to 43. The arithmetic modules 51 to 53 sequentially perform the deconvolution process and the upsampling processing. As a result, the image size is increased, and the number of channels is reduced.

In addition, the decoder 50 performs a combination process of combining a feature map generated by the encoder 40 with a feature map generated by the decoder 50. The DRAM 60 has a larger data storage capacity than the line memories comprised in the arithmetic modules 41 and 42 and temporarily stores feature maps FM1 and FM2 generated by the arithmetic modules 41 and 42. The DRAM 60 is an example of a “third memory” according to the technology of the present disclosure.

Each time the arithmetic module 41 performs the first convolution process once to generate data constituting a portion of the feature map FM1, the DRAM 60 stores the generated data. Similarly, each time the arithmetic module 42 performs the second convolution process once to generate data constituting a portion of the feature map FM2, the DRAM 60 stores the generated data. The arithmetic control unit 18 supplies the data stored in the DRAM 60 to the arithmetic modules 52 and 53 according to the timing required in a case where the decoder 50 performs the combination process.

Each time the arithmetic module 43 performs the third convolution process once to generate data constituting a portion of the feature map FM3, the generated data is supplied to the arithmetic module 51 of the decoder 50 without passing through the DRAM 60. The reason is that, since the combination process is performed in the arithmetic module 51 at a stage after the arithmetic module 43, it is not necessary to store the data generated by the arithmetic module 43 in the DRAM 60.

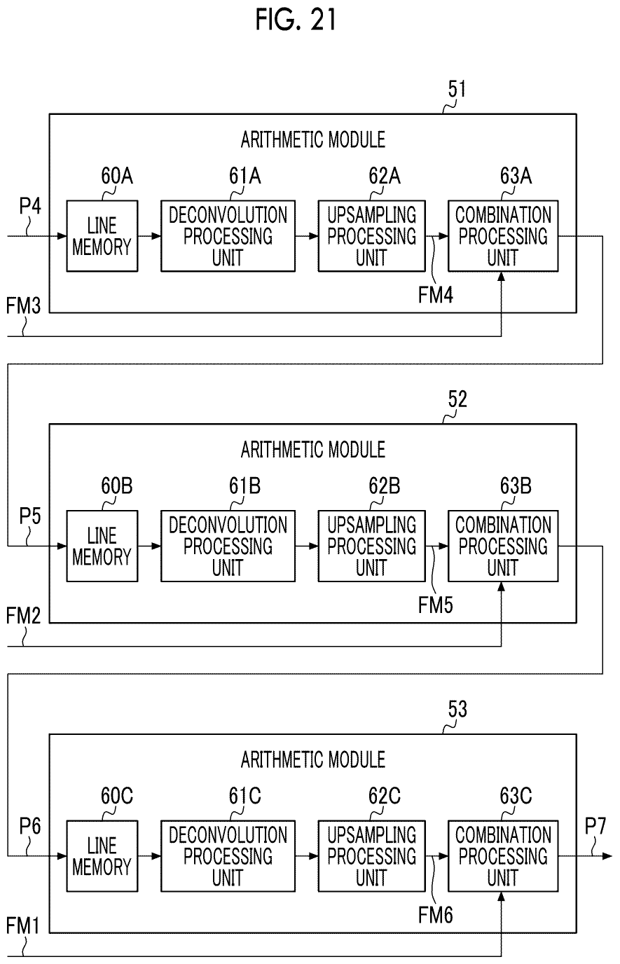

FIG. 21 illustrates an example of the configurations of the arithmetic modules 51 to 53 comprised in the decoder 50. The arithmetic module 51 comprises a line memory 60A, a deconvolution processing unit 61A, an upsampling processing unit 62A, and a combination processing unit 63A. The arithmetic module 52 comprises a line memory 60B, a deconvolution processing unit 61B, an upsampling processing unit 62B, and a combination processing unit 63B. The arithmetic module 53 comprises a line memory 60C, a deconvolution processing unit 61C, an upsampling processing unit 62C, and a combination processing unit 63C.

The image data P4 output from the encoder 40 is input to the arithmetic module 51. The image data P4 is stored in the line memory 60A for each of a plurality of row data items and is subjected to the deconvolution process by the deconvolution processing unit 61A. The number of channels is reduced by the deconvolution process of the deconvolution processing unit 61A. The upsampling processing unit 62A performs the upsampling process on the data output from the deconvolution processing unit 61A to generates a feature map FM4. The upsampling process is a process of increasing the number of pixels, contrary to the pooling process. In this embodiment, the upsampling processing unit 62A doubles the number of pixels of the image data in each of the vertical and horizontal directions.

The size of the feature map FM4 is the same as the size of the feature map FM3 supplied from the encoder 40. The combination processing unit 63A combines the feature map FM3 with the feature map FM4 to generate image data P5. For example, the combination processing unit 63A performs concat-type combination in which the feature map FM3 is added as a channel to the feature map FM4.

The image data P5 output by the arithmetic module 51 is input to the arithmetic module 52. The arithmetic module 52 performs, on the image data P5, the same process as the arithmetic module 51. The upsampling processing unit 62B performs the upsampling process on the data output from the deconvolution processing unit 61B to generate a feature map FM5. The size of the feature map FM5 is the same as the size of the feature map FM2 supplied from the encoder 40 through the DRAM 60. The combination processing unit 63B combines the feature map FM2 with the feature map FM5 to generate image data P6.

The image data P6 output by the arithmetic module 52 is input to the arithmetic module 53. The arithmetic module 53 performs, on the image data P6, the same process as the arithmetic module 51. The upsampling processing unit 62C performs the upsampling process on the data output from the deconvolution processing unit 61C to generate a feature map FM6. The size of the feature map FM6 is the same as the size of the feature map FM1 supplied from the encoder 40 through the DRAM 60. The combination processing unit 63C combines the feature map FM1 with the feature map FM6 to generate image data P7.

The image data P7 output by the arithmetic module 53 is input to the output unit 5. The output unit 5 further performs the deconvolution process on the image data P7 to generate image data for output and outputs the generated image data. The image data P7 has the same image size as the image data P1.

In addition, the arithmetic module 41 and the arithmetic module 42 of the encoder 40 correspond to a “first arithmetic module” and a “second arithmetic module” according to the technology of the present disclosure, respectively. In addition, the arithmetic module 41 is a “module that downsamples first image data” according to the technology of the present disclosure. The feature map FM6 corresponds to “feature image data stored in a third memory” according to the technology of the present disclosure. The image data P6 corresponds to “input image data” according to the technology of the present disclosure. The arithmetic module 53 corresponds to a “third arithmetic module that upsamples input image data” according to the technology of the present disclosure. The image data P7 corresponds to “first image data corrected using feature image data” according to the technology of the present disclosure. The combination of the feature maps is an example of “correction” according to the technology of the present disclosure.

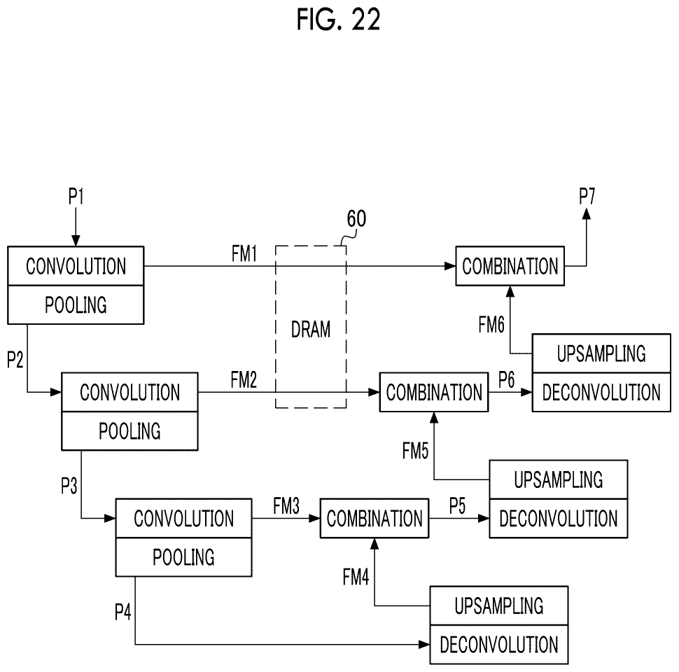

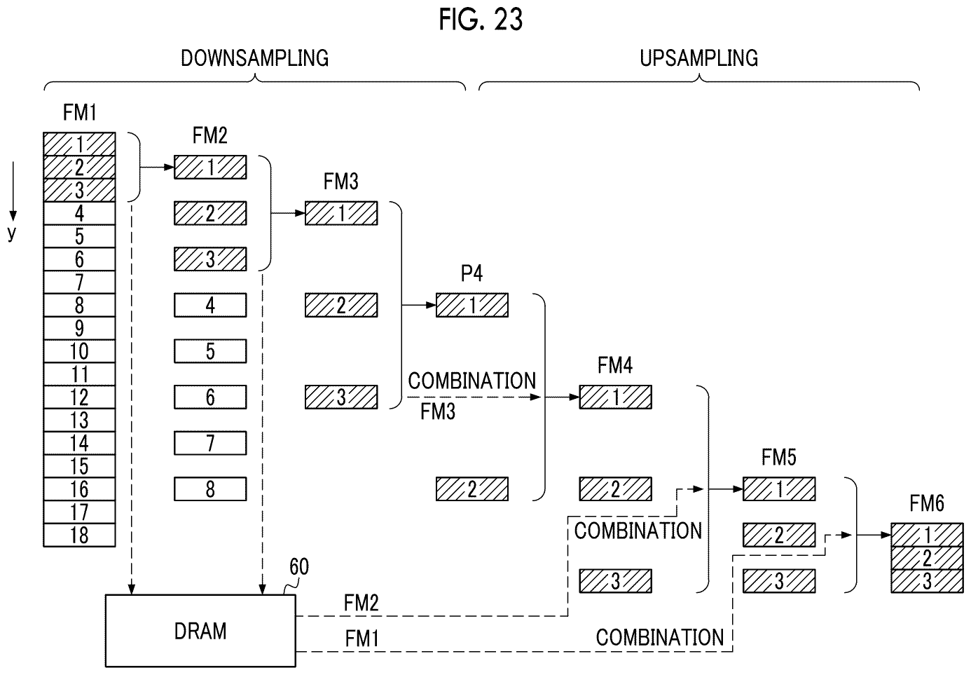

FIG. 22 conceptually illustrates a hierarchical structure of the CNN composed of the encoder 40 and the decoder 50. FIG. 23 illustrates pipeline processing performed on the feature maps FM1 to FM6.

In the pipeline processing, an eighteenth row of the feature map FM1 is generated at the time when a first row of the feature map FM1 is combined with a first row of the feature map FM6. Therefore, in a case where the DRAM 60 is not provided in the feature amount extraction unit 4B, it is necessary to hold the feature map FM1 corresponding to 18 rows at the time when the first row of the feature map FM1 is combined with the first row of the feature map FM6. It is necessary to increase the storage capacity of the line memory in order to store the feature map FM1 corresponding to 18 rows in the line memory (first memory) of the arithmetic module 41. Similarly, in a case where a first row of the feature map FM2 is combined with a first row of the feature map FM5, it is necessary to hold the feature map FM2 corresponding to eight rows. It is necessary to increase the storage capacity of the line memory in order to store the feature map FM2 corresponding to eight rows in the line memory (second memory) of the arithmetic module 42.

In this embodiment, the feature maps FM1 and FM2 generated by the arithmetic modules 41 and 42 are stored in the DRAM 60 (third memory) having a large data storage capacity, and necessary row data is transmitted to the arithmetic modules 52 and 53 according to the timing required for the combination process. As described above, since the DRAM 60 is provided, it is not necessary to increase the storage capacity of the line memories of the arithmetic modules 41 and 42. In addition, the DRAM 60 may store the feature maps FM1 and FM2 having the number of rows required in the combination process.

Further, the technology of the present disclosure is not limited to the digital camera and can also be applied to electronic apparatuses such as a smartphone and a tablet terminal having an imaging function.

Further, various processors can be used for the ALU that performs the convolution process. Similarly, various processors can be used for the arithmetic control unit, the pooling processing unit, and the upsampling processing unit. These processors include an IC and a processor, such as an FPGA, whose circuit configuration can be changed after manufacturing. The FPGA includes a dedicated electrical circuit, such as a PLD or an ASIC, that is a processor having a dedicated circuit configuration designed to execute a specific process.

Contents described and illustrated above are for detailed description of a portion according to the technology of the present disclosure and are only an example of the technology of the present disclosure. For example, the above description of the configurations, functions, operations, and effects is the description of examples of the configurations, functions, operations, and effects of the portions related to the technology of the present disclosure. Therefore, it goes without saying that unnecessary portions may be deleted or new elements may be added or replaced in the content described and illustrated above, without departing from the gist of the technology of the present disclosure. Furthermore, to avoid confusion and to facilitate understanding of a part according to the technology of the present disclosure, description relating to common technical knowledge and the like that does not require particular description to enable implementation of the technology of the present disclosure is omitted from the content of the above description and from the content of the drawings.

All of the documents, the patent applications, and the technical standards described in the specification are incorporated by reference herein to the same extent as each individual document, each patent application, and each technical standard is specifically and individually stated to be incorporated by reference.

What is claimed is:

1. An inference device for performing an inference using machine-learned data, the inference device comprising:
a first arithmetic module and a second arithmetic module that execute arithmetic processing including a convolution process and a pooling process,
wherein the first arithmetic module includes a first memory that stores a plurality of first row data items generated by dividing input first image data for each first number of pixels in a row direction and a plurality of first arithmetic units that execute a first convolution process on the plurality of first row data items,
the second arithmetic module includes a second memory that stores a plurality of second row data items generated by dividing input second image data for each second number of pixels in the row direction and a plurality of second arithmetic units that execute a second convolution process on the plurality of second row data items,
the number of channels of the first image data is different from the number of channels of the second image data, and
a first number, which is the number of the first arithmetic units that execute the first convolution process once on the plurality of first row data items in parallel, is different from a second number which is the number of the second arithmetic units that execute the second convolution process once on the plurality of second row data items in parallel.

2. The inference device according to claim 1,
wherein the second image data is image data including a feature amount that is generated by the execution of the arithmetic processing on the first image data by the first arithmetic module.

3. The inference device according to claim 2,
wherein the number of channels of the second image data is larger than the number of channels of the first image data, and
the first number is larger than the second number.

4. The inference device according to claim 3,
wherein the number of pixels processed in the second image data input to the second arithmetic module is smaller than the number of pixels processed in the first image data input to the first arithmetic module.

5. The inference device according to claim 1,
wherein the arithmetic processing by the first arithmetic module and the arithmetic processing by the second arithmetic module are executed in parallel.

6. The inference device according to claim 1,
wherein a unit of data storage in the first memory corresponds to the first number of pixels, a size of a filter used in the first convolution process, and the number of channels of the filter used in the first convolution process.

7. The inference device according to claim 6,
wherein a unit of data storage in the second memory corresponds to the second number of pixels, a size of a filter used in the second convolution process, and the number of channels of the filter used in the second convolution process.

8. The inference device according to claim 7,
wherein the number of filters used in the second convolution process is larger than the number of filters used in the first convolution process.

9. The inference device according to claim 1,
wherein the first row data is data corresponding to some rows of the first image data.

10. The inference device according to claim 1, further comprising:
a third memory that has a larger data storage capacity than the first memory and the second memory and that stores feature image data including a feature amount generated by the first arithmetic module; and
a third arithmetic module that upsamples input image data,
wherein the first arithmetic module is a module that downsamples the first image data, and
the third arithmetic module upsamples the input image data and generates the first image data corrected using the feature image data stored in the third memory.
